(19) United States
(12) Patent Application Publication
(10) Pub. No.: US 2013/0047091 A1
(43) Pub. Date: Feb. 21, 2013

(54) Web based process of ranking people in the world according to certain characteristic traits of physical appearance by other people in the world at the request of the former.

(71) Applicant: Sunil Wijeratne, Woodbridge, NJ (US)

(72) Inventor: Sunil Wijeratne, Woodbridge, NJ (US)

(21) Appl. No.: 13/554,068

(22) Filed: Jul. 20, 2012

Related U.S. Application Data
(60) Provisional application No. 61/525,775, filed on Aug. 21, 2011.

(51) Int. Cl. G06F 3/01

(52) U.S. Cl. 715/751

(57) ABSTRACT

Process by which people in the world are ranked according to certain characteristic traits of physical appearance they posses such as but not limited to beauty, attractiveness, desirability , sex appeal, by the other people in the world by expressing their judgment as they perceive the former aesthetically or otherwise to be in possession of a specific characteristic under consideration at the request and willing participation of the former in the process in which free and fair judgment of the latter on the characteristic being evaluated is sought for by the former.

### BACKGROUND OF THE INVENTION

A conventional beauty contest lacks fair participation and fair judgment: Ideal participation is the participation of every qualified person for the contest representing a particular geographic area. Participation via internet ensures much better participation compared to physical participation. Similarly fair judgment is the judgment by maximum number of judges rather than a participant is judged by a handful of judges. Judging via internet ensures maximum number of judges evaluating a given participant.

Lack of a justifiable and reasonably accurate process for evaluating certain characteristic traits of physical appearance of a person which allows a participant to know where he or she stands in the world has given rise to the formulation of this process.

This process is purely based on the philosophy “beauty is in the eye of the beholder”. This process invites the world focus on each individual to see how people across the world find others beautiful without boundaries or differences. Not only will it promote self-confidence and self-esteem but also would open up host of other potential opportunities such as carriers in modeling and acting

### SUMMARY OF THE INVENTION

This process allows people in the world to ascertain the degree of their desirability or aesthetic appeal of certain characteristics traits of physical appearance as perceived by the other people in the world via Internet.

What is claimed is:

1. A web based process by which participants subject to certain terms and conditions upload their photographs, videos or appear in person at a specific venue for their live images and performance on stage to be video broadcasted via internet to a website maintained for the purpose of participating and in ascertaining their rank or number of votes they may be able to acquire in the world on particular physical characteristic referred to at claim 11, hereinafter referred to as characteristic participants deemed to possess and so desire to be evaluated on. Judges referred to at claim 12, hereinafter referred to as judges voluntarily evaluate said photographs, videos, live broadcasts performance or any combination thereof by accessing the said website via internet and render their approval in the form of a vote as to a particular participant to be in possession of said characteristic. Periodically rank and the number of votes acquired by each participant based on the decision of judges is posted on the said website. This process has two salient advantages compared to other non-web based processes.

2. The web based process of claim 1, wherein participants are the people in the world who willingly participate themselves by submitting their photographs, videos and make themselves available at a specific venue for live video broadcasts of their images and performances on stage in the process of ascertaining their rank or total number of votes they may be able to acquire in the world on a particular characteristic as perceived by the judges in the world who find former to be in possession of a said characteristic under consideration by the judges hereinafter referred to as participants. Participant may participate in one or more characteristic traits of physical appearance to be evaluated by judges.

3. The web based process of claim 1, wherein participants subject to a set of terms and conditions among other conditions, prohibiting uploading of contents such as but not limited to pornographic, obscene, nude, vulgar, lewd, indecent may willingly upload their photographs of different costumes to be displayed on a web site on the Internet maintained for the purpose of ascertaining their rank or the number of votes they may be able to acquire in the world on a specific characteristic under consideration. Such photographs hereinafter referred as photographs.

4. The web based process of claim 1, wherein participants subject to a set of terms and conditions among other conditions, prohibiting uploading of contents such as but not limited to pornographic, obscene, nude, vulgar, lewd, indecent may willingly upload pre-recorded videos of their images and performance to be displayed on a web site on the Internet maintained for the purpose of ascertaining their rank or the number of votes they may be able to acquire in the world on a specific characteristic under consideration. Such pre-recorded video clips hereinafter referred as videos.

5. The web based process of claim 1, wherein performances are any act performed on a stage by a participant such as but not limited to performing art, singing, dancing, standup comedy, talent display, recital, playing of musical instrument hereinafter referred to as performance.

6. The web based process of claim 1, wherein participants subject to a set of terms and conditions among other things prohibiting display of performances such as but not limited to pornographic, obscene, nude, vulgar, lewd, indecent may willingly present themselves in person at a specific venue for the purpose of appearing and performing in order for such appearances and performances to be live video broadcasted via Internet to a website for the judges to view, evaluate and render their approval on the former on a specific characteristic under consideration. Such live video broadcast hereinafter referred as video broadcasts.

7. The web based process of claim 1, wherein the website is the website maintained on the Internet to facilitate participants to upload their photographs, videos and live video broadcasts where judges access to evaluate the contents provided by the participants.

8. The web based process of claim 1, wherein the rank is the relative position a participants stands in the world according to the number of approvals received by judges on a specific characteristic former desire to be evaluated on and in which former participates. Highest number of approvals received by a participant will be ranked the number one in the world and the rest are ranked accordingly.

9. The web based process of claim 1, wherein the votes are counted as the number of individual approvals received by participants from judges on the characteristic of the participant under consideration which sometimes is interchangeably termed as approval.

10. The web based process of claim 1, wherein the world is geographical areas of any part of the world such as a state (district, province, region or any geographic sub-division of a country), a country in the world or world as a whole hereinafter referred to as the world.

11. The web based process of claim 1, wherein the characteristic traits of physical appearance of people such as but not limited to being beautiful, sexy, voluptuous, curvaceous, sensuous, gorgeous, attractive, desirable, pretty, cute, centerfold ,bright, brilliant, picturesque, colorful, striking, dazzling, delightful, drop-dead, dream, easy on the eyes, elegant, enjoyable, exquisite, fine, flamboyant, foxy, gaudy, glittering, glorious, good-looking, grand, handsome, imposing, impressive, knockout, lavish, lovely, lulu, luxuriant, luxurious, opulent, ostentatious, pleasing, plush, pulchritudinous, ravishing, resplendent, showy, splendid, splendiferous, stunning, comely, bodacious, remarkable, outstanding, sublime, pleasing, delightful, sumptuous, superb, stylish, modish, exiting, appealing, radiating, glamorous, magnificent, great, or any combination thereof or in any word from such as in superlatives hereinafter referred to as characteristic.

12. The web based process of claim 1, wherein judges are the people in the world who voluntarily evaluate photographs, videos, or video broadcasts of the participants posted or displayed on the website via Internet for the purpose of determining and rendering their approval on a particular characteristic of a participant being evaluated.

13. The web based process of claim 1, wherein Judgment issued in respect of a characteristic of a participant being considered by viewing photographs , videos or video broadcast via Internet during ranking process and then clicking a computer mouse or any similar input device on a mechanism such as but not limited to buttons, icons, words, labels, symbols, voice commands provided for each posted or displayed photographs, videos, or video broadcasts in expressing approval of the judge to indicate that the participant to be in possession of the said characteristic hereinafter referred to as approval . For instance a judge may click a button, symbol or icon marked such as but not limited to “vote”, “Like”. “Approve”, “Beautiful” provided on a photographs, to indicate that the said participant is beautiful and will be counted the approval as a vote. Judgment is purely subjective as the way judges perceive the participant whether to be in possession of the said characteristic or not.

14. The web based process of claim 1, wherein the final decision on ranking or posting total number of votes acquired by each participant is done periodically (monthly or in terms of several months and annually). Such a period is hereinafter referred as the period.

15. The web based process of claim 1, wherein the process consists of participants and judges. Participants who participate in ascertaining their rank in the world in a particular characteristic and request judges to evaluate a former to be in possession of a certain characteristic may submit photographs and/or, videos and/or subject themselves for a video broadcast to be evaluated and approve by the judges. Judges view and evaluate photographs, videos and live video broadcast s via Internet and render their approval on any participant on the characteristic being evaluated. Each such approval is counted as a vote for the participant and total vote counts acquired by each participant will be posted on the website and will be used in determining the rank of the participant in the world for the said characteristic which will be publicly announced.

16. The web based process of claim 1, wherein advantages of this process compared to other non web based processes are of twofold: fair representation and fair judgment. Maximum participation of participants via Internet ensures a fair representation of a given geographical area. Maximum participation of judges via Internet ensures a fair judgment and the true meaning of world ranking whereas traditional processes employ only a handful of judges.
